(19) United States
(12) Patent Application Publication
(10) Pub. No.: US 2007/0006077 A1
(43) Pub. Date: Jan. 4, 2007

(54) Sectorizing a display to present audience targeted information within different ones of the sectors

(75) Inventor: Andrew Grubbs, Seffner, FL (US)

Correspondence Address: AKERMAN SENTERFITT, P.O. BOX 3188, WEST PALM BEACH, FL, 33402-3188, US

(73) Assignee: i7 CORP, Tampa, FL (US)

(21) Appl. No.: 11/172,044

(22) Filed: Jun. 30, 2005

(51) Int. Cl. H04N 5/44; H04N 5/445

(52) U.S. Cl. 715/716; 725/38

(57) ABSTRACT

A media presentation method can include the step of identifying a display capable of presenting audio/video content. A viewing area of the display can be divided into more than one sector. Programmatically established criteria can be used to selecting a media production from a pool of available productions to be presented in each of the sectors. The selected media productions can be simultaneously presented within the display. In the method, a broker can determine a set of media productions available for selection and can establishes at least a portion of the programmatically established criteria used to select media productions. The broker can be a media distributor that does not commercially distribute the media productions for presentation in non-sectorized displays.

### BACKGROUND

1. Field of the Invention

The present invention relates to the field of media distribution and, more particularly, to presenting audience targeted information upon a sectorized display.

2. Description of the Related Art

Waiting rooms are often equipped with audio/video displays, such as television sets or computer monitors, which occupy the attention of individuals present in the waiting rooms. Typically, media productions presented within waiting room television sets are obtained from standard broadcast sources, including network television sources and cable television sources. Video and/or DVD media productions can also be presented upon the displays instead of standard broadcast productions.

A few attempts have been made to present media productions upon the displays, where the media productions are derived from non-standard sources. For example, many airports provide an airport specific broadcast that is presented upon displays located within airports. In another example, a number of retail chains, such as BLOCKBUSTER and WALMART, have established a chain-specific broadcast lineup and/or a series of video presentations that are presented upon displays located within multiple retail chain locations.

Conventional methodologies utilize the entire viewing area of the display to present content provided by a single source. Additionally, media productions presented upon displays at locations (referred to as captive locations) having audiences (referred to as a captive audience) that are constrained to wait in the locations for at least a period of time fail to customize media productions towards characteristics of the captive audiences. Accordingly, an opportunity for targeted advertising and/or for targeted content distribution is lost. What is needed is a content distribution methodology capable of customizing media productions for captive audiences, where space of the displays at captive locations can be reserved for advertiser-provided content in a manner independent of other broadcast media productions presented upon the displays.

### SUMMARY OF THE INVENTION

The present invention provides a technique for sectorizing a display so that different media productions can be presented within different sectors at the same time. The sectors can contain media obtained from different sources, such as a television broadcast source, a data repository source, an Internet video streaming source, an advertiser source, and the like.

In one embodiment, the display can be contained in a captive location having a captive audience, such as a physician's office. Information and characteristics of the captive audience can be gathered and used to select media productions appropriate for the captive audience. For example, one sector of the display can present a movie believed to be appealing to the captive audience, while another sector of the display can present advertisements targeted to the captive audience.

The entity that assigns the different media productions to the various sectors of the display can be a value-added media distributor that controls the sectorization of multiple displays. For example, the media distributor can sell advertising space and information space upon sectorized displays to interested parties. Unlike a traditional media broadcaster that sells a time division (such as a division for a thirty second commercial) within a designated media production, the media distributor sells a space division within one or more viewing sectors of one or more space-divided displays.

When multiple displays are utilized, each display can be assigned display-specific media productions. For example, different displays can be viewed by different audiences for which audience-specific characteristics are known. Media productions selected for presentation within each display can be based in part upon the audience-specific characteristics, which causes the media productions selected for each display to differ from one display to the next.

Additionally, when multiple displays are utilized, media productions can be coordinated among the multiple displays. For example, multiple displays can include digital billboards that target automobile drivers. Each billboard can be configured to display content in a sequenced fashion, so that a vehicle driver is presented with part one of a media production within a first billboard, part two of the media production within a second billboard a designated distance from the first billboard, part three within a third billboard, and so forth. For purposes of the present invention, vehicle drivers viewing the billboards can be considered a captive audience and the sequence of billboards along a highway can be considered a captive location.

The present invention can be implemented in accordance with numerous aspects consistent with material presented herein. For example, one aspect of the present invention can include a media presentation method. The method can include the step of identifying a display capable of presenting audio/video content. A viewing area of the display can be divided into more than one sector. Programmatically established criteria can be used to select a media production from a pool of available productions to be presented in each of the sectors. The selected media productions can be simultaneously presented within the display.

In one embodiment of the method, a broker can determine a set of media productions available for selection and can configure at least a portion of the programmatically established criteria used to select media productions. The broker can be a media distributor that does not commercially distribute the media productions for presentation in non-sectorized displays. That is, the broker can be a “value added” media distributor that re-formats existing media productions for presentation in the sectorized displays.

Another aspect of the present invention can include a media distribution method that includes the step of identifying two or more displays located at multiple locations. A viewing area of each of the displays can be divided into two or more defined sectors. Each sector can be configured to present a sector-specific media production. One of the defined sections, which by viewing area can be the largest of the defined sectors, can present an audio/video media production provided by an audio/video media source. Another of the defined sectors can present advertising media. Accordingly, presentation space of advertising sectors can be sold to advertisers. Purchased presentation space can permit advertisers to display advertiser-specified content within one or more advertising sectors of one or more displays.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for presenting media content within sectorized displays in accordance with an embodiment of the inventive arrangements disclosed herein.

FIG. 2 is a schematic diagram of a system for associating media productions with sectors of a display in accordance with an embodiment of the inventive arrangements disclosed herein.

FIG. 3 is an illustrate screen of a sectorized display in accordance with an embodiment of the inventive arrangements disclosed herein.

FIG. 4 is a method for presenting media within a sectorized display in accordance with an embodiment of the inventive arrangements disclosed herein.

FIG. 5 is a method for distributing media content in accordance with an embodiment of the inventive arrangements disclosed herein.

### DETAILED DESCRIPTION OF THE INVENTION

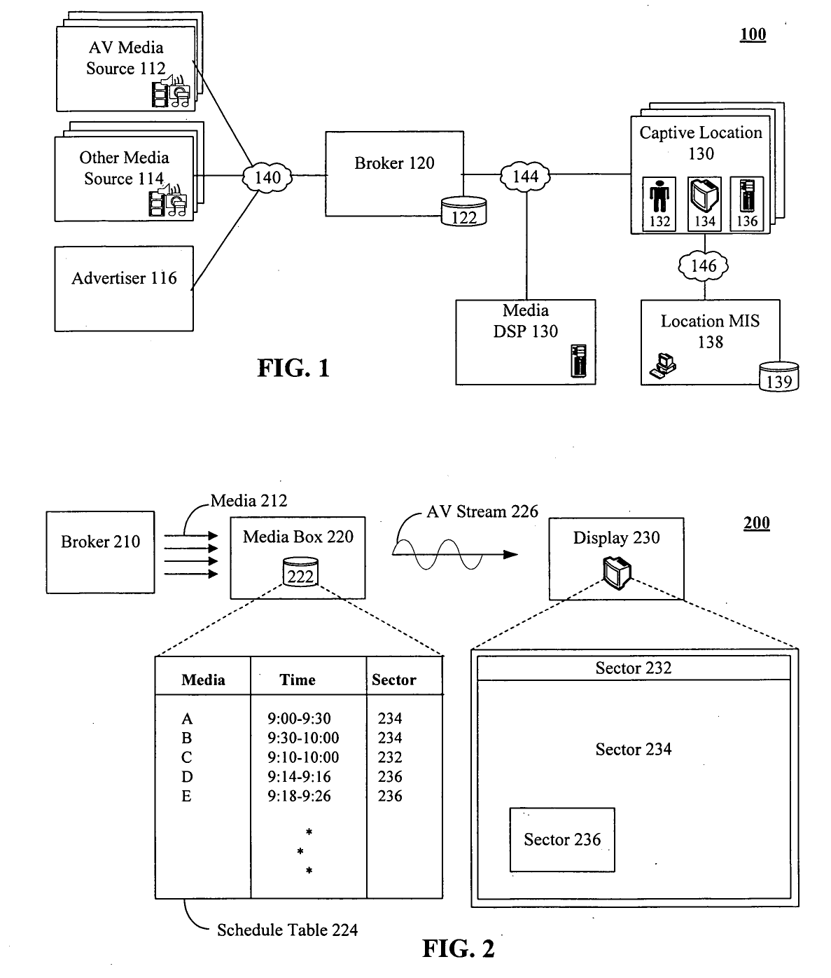

FIG. 1 is a schematic diagram of a system 100 for presenting media content within sectorized displays in accordance with an embodiment of the inventive arrangements disclosed herein. System 100 can include a captive location 130 having a captive audience 132, a display 134, and/or a media box 136. Captive location 130 can be linked to location management information system (MIS) 138 via network 146 and to broker 120 via network 144. A media digital signal processor 130 can also be linked to network 144. Broker 120 can be communicatively linked to AV media source 112, other media source 114, and advertiser 116 via network 140.

As used herein, a captive location 130 can be any location that includes one or more people for a duration. Captive location 130 can include a waiting room where people gather while waiting for a desired service. The captive location 130 can also include a geographical region within which people are confined, which can include both indoor and outdoor locations. For example, captive location 130 can include a physician's waiting room, an airport waiting area, a den area of a house, an area viewable from line to a service station/cash register, an area along a highway along which a series of billboards are located, and the like. A captive audience 132 can include one or more people proximately positioned within or about the captive location 130.

The display 134 can be any device capable of presenting media productions including, but not limited to, a television, a computer monitor, a media projection device, a mobile communications device, a wearable-computing device, and similar equipment. In one embodiment, the display 134 can present streamed audio video content. In another embodiment, the display 134 can receive a file or packet containing digitally encoded content, can decode the content, and can present the decoded media production using a visual presentation means and/or an audio presentation means.

Media productions can include audio/video productions, such as movies, television shows, cartoons, broadcast sporting events, and similar programs. Media productions can also include pictures, photos, graphical content, text-based documents, icons, and logos. Additionally, media productions can include songs, speech, and other audibly presentable content. Further, media productions can include live broadcasts, previously recorded productions, and interactive productions. Interactive productions can be defined as productions permitting viewer interaction, such as live call-in shows, chat or other Internet-enabled forums, and the like.

It should be appreciated that any of a variety of technologies can be used in conjunction with presenting the media productions. In an embodiment where one of the media productions includes an interactive production, individuals of the captive audience 132 can interact with presented content of the interactive production using a short message service (SMS), a text messaging service, a transmission control protocol/Internet Protocol (TCP/IP), or other information conveyance technology.

For example, using a fixed/constant telephone number, an advertisement contained within an interactive production can include a unique code for that advertisement or a unique code for that advertisement and the captive location 130 at which the advertisement is displayed. The display 134 can conspicuously display instructions on how to send an advertisement code via a mobile phone using SMS text messaging. Responsive to sending the code, the phone user can obtain advertiser contact information, a coupon, a sweepstakes entry, and the like. Obtained information can be presented upon the display 134 and/or upon the mobile phone. The same code can be sent from the same mobile device a second time to indicate a willingness to allow an agent of the advertiser to directly contact the individual at the mobile device's number. The second sending of the code from the same mobile device can have other meaning. For example, the second (or subsequent) sending of the code can include a desire for an advertisement, a request for additional information, an agreement to purchase an advertised item, and the like.

It should be appreciated that media programs can also use the same technique for audience participation activities including voting, submitting a question, participating in a quiz show, and the like.

Media box 136 can include an electronic device communicatively linked to the display 134 that permits the presentation of selected media production within assigned sectors. Media box 136 can be a stand alone electronic device, can be a software device executing within a computer, can be a device integrated with display 134, and can be a device integrated into another appliance, such as a cable box, a personal video recorder, or a television gaming system.

In one embodiment, media box 136 can generate a single media stream containing multiple media productions, each presented within an assigned sector. The media stream can be generated from one or more different files and or/streams, each containing a media production. For example, media box 136 can receive a television broadcast from audio/video media source 112 via an analog media stream, can receive an advertisement audio/video production from other media source 114 via a digital media stream, can retrieve stock and weather information from Internet sources, and can access data store 122 maintained by broker 120 to obtain advertising media. After receiving the media productions, the media box 136 can assign each of these media productions to a sector of the display 134. The media box 136 can adjust the content of each media production to fit within an assigned sector. The media box 136 can then generate a signal formatted for presentation within the display 134 that includes the adjusted media content.

In another embodiment, the media box 136 can include criteria for selecting media productions. The media box 136 can use these criteria to programmatically determine which media productions from a set of available media productions are to be presented within particular sectors. In one embodiment, the criteria used by the media box 136 can include a schedule associating media productions with time slots and sectors.

In yet another embodiment, the criteria can include an explicit user selection. For example, a member of the captive audience 132 and/or captive location 130 owner can decide what media presentation is to be presented within one or more of the sectors. A remote control or a television switch can be used by the member or owner to select which media presentation is to appear within a sector of the display 134. Moreover, an option exists to move from one sector to another, allowing for a user selection of content within each sector of the display 134.

In one embodiment, the television switch can be a switch contained within a Web site. Viewers, administrators, or any authorized personnel can access the Web site via a Web browser. The user can input commands into the Web browser to select one or more media presentations for the display 134. In response, the selected media productions can appear within display 134. Additionally, the Web site can permit the scheduling of media productions within one or more of the displays 134 at user specified times.

In still another embodiment, the criteria can include a series of logical rules that permit a situational selection of media productions for different sectors. For example, the criteria can be based upon characteristics of the captive audience 132 and corresponding characteristics specified by advertisers. Comparing these characteristics can enable an advertiser to target advertising to a known audience.

Media selection criteria and rules can also be based upon media that is to be simultaneously presented in other sectors. That is, content presented within one sector can affect content that is to be presented within another sector. For example, when a television program contained within one sector is presenting media relating to beer, an advertisement for beer can be selected for presentation within another one of the sectors.

Information pertaining to the characteristics of the captive audience 132 and/or content being presented in sectors can be obtained from one or more external sources, one such source being broker 120. Another external source can include a location management information system (MIS) 138. As used herein, MIS 138 can be any system that contains information about the captive location 130, the captive audience 132, and/or people within the captive audience 132. The MIS 138 can include or be communicatively linked to a customer relationship management system (CRMS).

For example, when the captive location 130 is a physician's waiting room, a physician's intake system (part of MIS 138) can provide information of which patients are actually present within the captive location 130. Additionally, the physician's MIS 138 can also include substantial personal information for each patient within the waiting room. The media box 136 can receive this information and select media productions for sectors accordingly.

For instance, if one of the patients in the captive location 130 is suffering from allergies as recorded by MIS 138, the media box 136 can receive this information, and can responsively select an advertisement for ALLEGRA or CLARITIN to be presented in one of the sectors. It should be appreciated that because the media box 136 is configured to perform its selections automatically based upon programmatically established criteria, privacy information from the MIS 138 used by media box 136 is not disclosed to any third party and confidentiality of the information can be maintained.

Media digital signal processor (DSP) 130 can be a computing device capable of performing digital signal processing operations against media productions. For example, media DSP 130 can be utilized by the media box 136 to convert media productions from an initial format into a format capable of fitting within an assigned sector. In one embodiment, broker 120 can utilize media DPS 130 to modify media content obtained from media source 112 or 114 in accordance with advertiser 116 goals. For instance, a sign included within a movie can advertise PRODUCT A. Broker 120 can use media DSP 130 to modify the in-movie advertisement to advertise PRODUCT B instead.

It should be appreciated that Media DSP 130 can utilize any variety of known techniques in the art to perform DSP functions on audio, images, and video. Processing of media productions can require manual manipulations by skilled technicians or can be an automated process.

For example, optical character recognition technologies can be used to optically recognize text presented within images and/or video and speech recognition technologies can be used to speech recognize utterances within audio. Additionally, a closed-caption feed or other type of feed can be scanned to obtain “recognized text”. Recognized text can be compared against an established list (such as product names). Each item in the list can be associated with a replacement text, which can be substituted within the media stream (using audio processing techniques in the case of audio substitutions and graphical processing techniques in the case of visual substitutions).

In such a manner, a spoken product name appearing in a media production can be automatically substituted with a different spoken product name. Similarly, visually presented products shown in a media production, such as a container of DRINK A, can be substituted with a different product, such as a container of DRINK B. Operations performed by the Media DSP 130 can occur in a time delayed fashion or can occur in real time or in near-real time.

Networks 140, 144, and 146 can represent any communication mechanism capable of conveying analog or digitally encoded information. Each of the networks 140, 144, and 146 can include a telephony network like a public switched telephone network (PSTN), a mobile telephone network, a computer network, a cable network, a satellite network, a broadcast network, and the like. Further, each of the networks 140, 144, and 146 can use wireless as well as line-based communication pathways.

Digitally encoded information can be conveyed via network 140, 144, and 146 in accordance with any communication protocol, such as a packet-based communication protocol or a circuit-based communication protocol. Additionally, information conveyance across networks 140, 144, and 146 can occur in an open or secured fashion. For example, communications over networks 140, 144, and 146 can use Secured Socket Layer (SSL) connections, can use private/public key encryption techniques, and can utilize Virtual Private Network (VPN) technologies.

In operation, a broker 120 can control the presentation of content via displays 134 located within multiple captive locations 130. The broker 120 can obtain media productions from at least one audio/video media source 112 as well as from other media sources 114. The obtained media productions can be presented within defined sectors of one or more displays 134 at one or more captive locations 130. A media box 136 can be used to control the presentation of media content within the defined sectors. A media digital signal processor 130 can be used to modify media productions supplied by media sources 112 and 114.

Broker 120 can sell sectorized advertising space within display 134 to one or more advertisers 116. An advertiser 116 purchasing space can be allowed to present advertiser-specific content upon the display 136. The purchased advertising space can include space within a sector of the display 134.

In one embodiment, advertising space can be sold based in part upon characteristics of audience 132 of the captive location 130. The characteristics can be general characteristics for an audience expected to be in the captive location 130 or can be characteristics associated with individuals determined to be located at the captive location 130. For example, individual specific characteristics can be obtained from data store 139 associated with location management information system 138.

It should be appreciated that the arrangements shown in FIG. 1 are for illustrative purposes only and that the invention is not limited in this regard. The functionality attributable to the various components can be combined or separated in different manners than those illustrated herein.

In one contemplated embodiment, for example, system 100 can operate without a media box 136. In the embodiment, a server from a centralized location, such as from a location local to broker 120, can construct at least one display presentation signal, which includes multiple sectorized media productions, and convey the constructed signal to multiple displays 134 in a display targeted fashion. Displays 134 can be targeted based upon a uniquely identified IP address, MAC address, site key number, or some other identifier. Displays 134 can also receive multiple media streams (each stream including a complete set of sectorized media productions) sent from the centralized server, can select one of these streams using filtering criteria local to the display 134, and can present media contained within the selected stream.

In another contemplated embodiment, the broker 120 need not be a separate entity from the audio/video media sources 112, the other media source 114, and/or advertiser 116. Similarly, the media sources 112 and 114 need not be separate entities from advertiser 116. For example, the broker 120 can advertise space for sale within display 134, at which point the broker 120 operates as both advertiser 116 and broker 120. Broker 120 can also present broker-created media programs within one or more sectors of display 134, which would allow broker 120 to be a media source, such as media source 112 or 114. Similarly, media source 112 can choose to advertise one or more programs, which would allow media source 112 to operate as both a media source and as advertiser 116.

FIG. 2 is a schematic diagram of a system 200 for associating media productions with sectors of a display in accordance with an embodiment of the inventive arrangements disclosed herein. In system 200, broker 210 can provide multiple media productions 212 to media box 220. A portion of these media productions can be stored in data store 220 accessible to media box 220 to be utilized when needed.

The media box 220 can include a schedule table 224 that establishes criteria for presenting media within display sections at particular times. In one embodiment, the schedule table can be generated or configured by broker 210. The schedule table 224 can be also automatically generated by the media box 220 based upon established media program selection criteria and selection rules.

Schedule table 224 can include columns for media, time, and sector. For example, media A can be associated with a time of 9:00 to 9:30 and can be associated with sector 234. Only one media program can be associated with a particular sector for a designated time. Different media, however, can be associated with different sectors. For example, media C can be associated with sector 232 and a time of 9:10 to 10:00.

One or more additional tables can be used in cooperation with the schedule table 224. For example, an available media table (not shown) can list, for a time slot, one or more available media presentations. Within the available media table, media D, E, F, G, H, and I can be associated with time slot 9:00 to 9:30 and with sector 236. The media box 220 can select media programs from the available media table to generate entries of the schedule table. For example, media D and E can be selected from the available media table, resulting in media D being assigned time 9:14 to 9:16 for sector 236 in the schedule table and media E being assigned time 9:18 to 9:26.

In one embodiment, when no media is associated with a sector for a given time, a default media program, such as a blank screen area or a logo presentation, can be provided for that sector. Alternatively, a fall back media presentation can be assigned to the sector for the unassigned duration. In a particular embodiment, advertisers can receive a discounted rate for advertising media within unassigned sectors. In another embodiment, when one sector is unassigned for a significant duration (defined as a duration exceeding a previously established threshold), the sectorized display can be dynamically readjusted to remove the unassigned sector, thereby expanding the viewing space of non-removed sectors.

The media box 220 can construct an audio/video stream 226 that contains media content formatted in accordance with the schedule table 224. The display 230 can render the audio/video stream. The display 230 can include sector 232, 234, and 236.

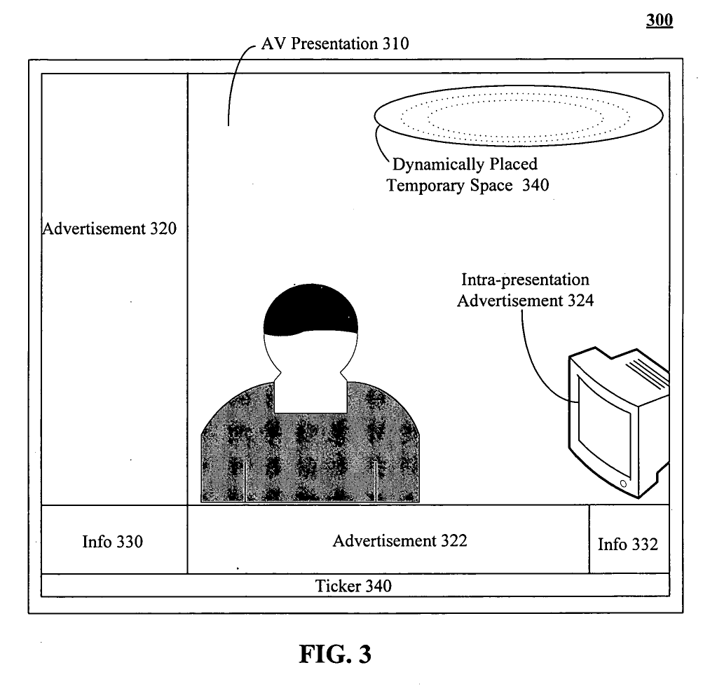

FIG. 3 is an illustrative screen 300 of a sectorized display in accordance with an embodiment of the inventive arrangements disclosed herein. Screen 300 can be presented in the context of any display having sectorized content, such as display 134 or 230.

Screen 300 illustrates an audio/video presentation sector 310, advertisement sectors 320 and 322, information sectors 330 and 332, and ticker sector 340. Audio/video presentation sector 310 can be reserved for presenting an audio/video media production provided by an audio/video media source. The audio/video media source can commercially distribute said audio/video media production so that the media production is able to be presented upon non-sectorized displays. That is, sector 310 can display commercially available broadcasts and movies.

Because the audio/video presentation sector 310 can attract the attention of an audience and be of primary interest to the audience, a viewing area allocated to sector 310 can be greater than any other viewing area within screen 300. Additionally, sound emitting from a device including screen 300 can be obtained from an audio/video media production presented within the audio/video presentation sector 310.

Advertisement sectors 320 and 322 can be sectors reserved for presenting advertisements, which can be paid for by advertisers. Unlike conventional advertisements, the advertisements presented within advertisement sector 320 and 322 can be obtained from a separate source that provides content for audio video presentation sector 310. For example, the separate source can be an Internet source, a data storage source, or a different broadcast source. Additionally, because the advertisements presented within sectors 320 and 322 are not being broadcast in a traditional fashion, content presented in sectors 320 and 322 need not be approved by authorities associated with traditional broadcasts. Instead, different rules, which may or may not be established by the same authorities that are responsible for traditional broadcasts, can apply to content presented in accordance with method 300.

Information sectors 330 and 332 can be reserved for presenting information including, but not limited to, weather, a current time, a current date, current stock information, and current news. Content within information sectors 330 and 332 can be customized for the location where the screen 300 is being presented. So that if the presentation occurs within Miami, Fla., weather and time for Miami, Fla. are presented therein.

One or more of information sectors 330 and 332 can present information in a rotating fashion. That is, content presented within information sectors 330 and 332 can be time divided into different segments. Thus, within a single information sector, a weather time segment can be preceded by a news segment, which can be proceeded by a time of day segment, and so forth.

The ticker sector 340 can be reserved for presenting text-based information in a scrolling fashion. For example, the ticker can be a stock ticker, a sports score ticker, a news ticker, and the like. The ticker section 340 is not limited to textual content, and graphical and video elements can also be included. For instance, each stock displayed within a stock ticker is often preceded by icon of an up or a down arrow.

Although sections 310, 320, 322, 330, 332, and 340 can be implemented in a stationary and static fashion, the invention is not limited in this regard. In one embodiment, the viewing areas of one or more of the sectors can be dynamically adjusted and/or removed. For example, advertisement sector 320 can be dynamically removed from screen 300 resulting in a width of audio/video presentation section 310 being expanded. Additionally, sectors designed to be non-statically positioned are contemplated.

Dynamically placed temporary space 350 is one such sector. Space 350 can be placed on top of sector 310, obscuring a portion of media content that would otherwise be viewable. Space 350 can be assigned to a media production in the same manner that other sectors can be assigned. Unlike other sectors, however, space 350 can appear upon screen 300 (zoom in), can present an assigned media production, and can disappear (zoom out).

Additionally, space 350 as shown in screen 300 illustrates that dynamic spaces and/or sectors are not limited to rectangular viewing areas, but can instead be an area having any two or three dimensional shape, such as an oval, sphere, polygon, tetrahedron, star, and the like.

Intra-presentation advertisement 324 can be a special sector that is presented within audio/video presentation 310. Unlike dynamically placed temporary space 350, which overlays media within sector 310, intra-presentation advertisement 324 is integrated with the content of sector 310. Placing content within intra-presentation advertisement 324 can require that digital signal processing operations be performed upon the media production that it is integrated within.

In one example, a television set can appear within the media content of sector 310. The media content originally shown in the television set can be replaced with customized content. While any content replacement can occur, intra-presentation advertisement 324 is typically used to unobtrusively substitute items within a movie or television program with advertiser specified items.

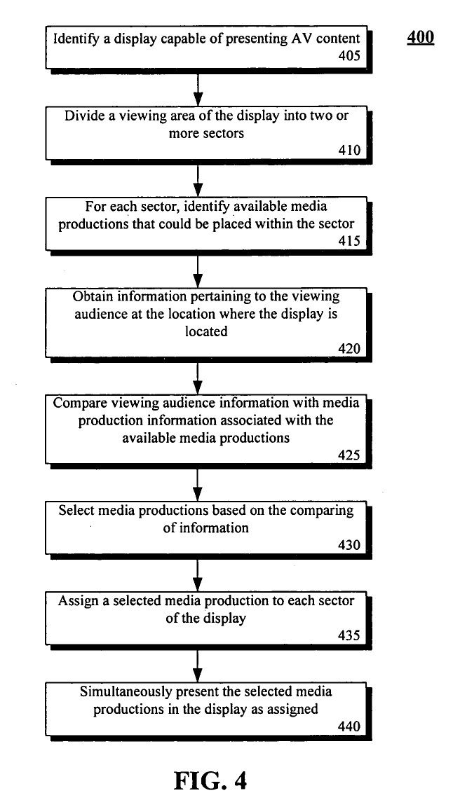

FIG. 4 is a method 400 for presenting media within a sectorized display in accordance with an embodiment of the inventive arrangements disclosed herein. Method 400 can be performed in the context of a system 100 or 200 as well as in the context of a system including a display having a screen 300.

Method 400 can begin in step 405 where a display capable of presenting audio/video content can be identified. In step 410, a viewing area of the display can be divided into two or more segments. In step 415, for each sector, a set of available media productions can be identified. Different sectors can be reserved for different types of media productions so the set of available media productions can vary from sector to sector.

In step 420, information pertaining to a viewing audience at a location where the display is positioned can be obtained. In one embodiment, the audience information can be rarely updated information based upon an expected audience associated with the viewing location. In another embodiment, actual data can obtained for the actual audience present at the viewing location. Further, the audience information can identify data specific to individuals within the audience.

In step 425, the viewing audience information can be compared with media presentation information associated with available media productions. In step 430, media productions can be selected based upon the comparing of information from step 425. In step 435, a selected media production can be assigned to each sector. In step 440, the selected media productions can be simultaneously presented within the display as assigned.

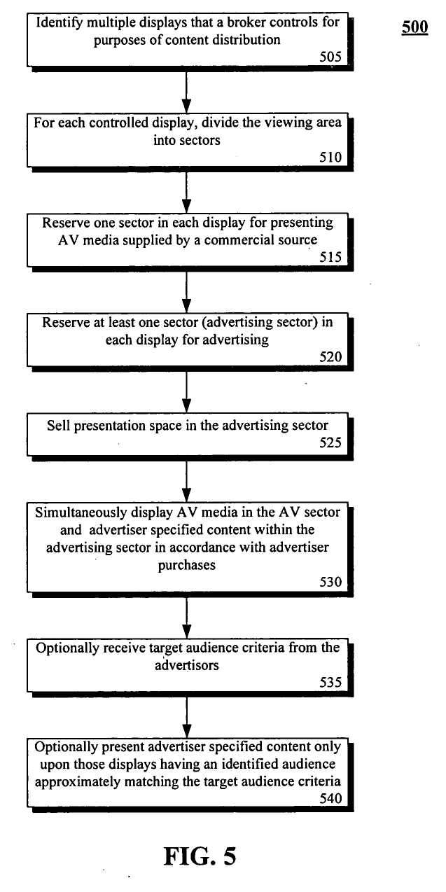

FIG. 5 is a method 500 for distributing media content in accordance with an embodiment of the inventive arrangements disclosed herein. Method 500 can be performed in the context of a system 100 or 200 as well as in the context of a system including a display having a screen 300.

Method 500 can begin in step 505, where multiple displays can be identified where a media broker controls the distribution of content to the multiple displays. In step 510, for each controlled display, the viewing area can be divided into sectors. In step 515, one of the sectors in each display, referred to as an audio/video sector or audio/video presentation sector, can be reserved for presenting media supplied by a commercial audio/video source. In step 520, one of the sectors in each display, referred to as an advertising sector, can be reserved for advertising.

In step 525, presentation space in the reserved advertising sectors can be sold. In step 530, audio/video media can be displayed in the audio/video sector of at least a portion of said displays at the same time that advertiser content is presented within the advertiser sector of the displays. Different displays can present different content in each of the sectors. Additionally, a selection of the content presented within the different displays can be based at least in part upon characteristics of the audience viewing the displays.

To illustrate, in optional step 535, target audience criteria can be received from advertisers. In step 540, advertiser specified content can be presented upon only those displays having an identified audience that approximately matches the target audience criteria. It should be appreciated other content, such as the audio/video media content and informational content can also be selectively presented based upon characteristics of the viewing audience.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A media presentation method comprising the steps of:
identifying a display capable of presenting audio/video content;
dividing a viewing area of said display into a plurality of sectors;
for each sector, selecting a media production in accordance with programmatically established criteria; and
simultaneously presenting said selected media productions within said display, wherein a broker determines a set of media productions available for selection and establishes at least a portion of said programmatically established criteria used in the selecting step, wherein said broker does not commercially distribute said media productions for presentation in non-sectorized displays.

2. The media presentation method of claim 1, further comprising:
identifying personal information for an audience at a location where the display is located;
wherein the selecting step is based in part upon the identified personal information, wherein at least a portion of the selected media productions is targeted to the audience based upon the identified personal information.

3. The media presentation method of claim 1, wherein the location is a captive location, wherein the audience comprises a captive audience.

4. The media presentation method of claim 3, wherein selecting step is specifically performed for said captive location based in part upon the service associated with the captive location.

5. The media presentation method of claim 3, further comprising the steps of:
identifying changes in a composition of said captive audiences over time;
determining audience characteristics specific to the captive audience present at the captive location at different times;
for each of the different times, customizing the selecting step in accordance with corresponding ones of said determined audience characteristics.

6. The media presentation method of claim 5, wherein the identifying step identifies specific captive individuals included within the captive audience, wherein the identified captive individuals change over time, wherein the determining step determines individual characteristics associated with the identified captive individuals, and wherein the customizing step is based in part upon the determined individual characteristics.

7. The media presentation method of claim 6, wherein the identifying step utilizes audience composition information obtained from a scheduling software application associated with said captive location.

8. The media presentation method of claim 6, wherein the determining step utilizes individual characteristics obtained from a management information system associated with said captive location.

9. The media presentation method of claim 3, further comprising:
permitting an entity that provides said service to specify programmatic criteria used in said selecting step.

10. The media presentation method of claim 1, where at least one of the plurality of sectors is a program sector reserved for presenting an audio/video media production provided by an audio/video media source, wherein the audio/video media source commercially distributes said audio/video media production so that the media production is able to be presented upon non-sectorized displays.

11. The media presentation method of claim 10, wherein a viewing area of the program sector is greater than a viewing area associated with of any other one of the plurality of sectors.

12. The media presentation method of claim 11, wherein sound emitting from an audio transducer associated with the display is obtained from said audio/video media production.

13. The media presentation method of claim 10, wherein at least one of the plurality of sectors is an advertisement sector reserved for presenting advertisements obtained from a source other than said audio/video media source.

14. The media presentation method of claim 13, wherein space within said advertisement sector is sold by said broker to advertisers.

15. The media presentation method of claim 14, wherein said advertisers pay for space within said advertisement sector based in part upon characteristics identified with a captive audience determined to be at a location where the display is located at a time a media production associated with said advertisers is presented

16. The media presentation method of claim 13, within at least two of said plurality of sectors are advertisement sectors.

17. The media presentation method of claim 10, wherein at least one of the plurality of sectors is an information sector that presents at least one of a weather, a current time, a current date, current stock information, and current news.

18. The media presentation method of claim 17, wherein said information comprises a rotating information space that is divided into time segments, where a different information is presented within different ones of the time segments.

19. The media presentation method of claim 17, wherein said information sector comprises entity specific information corresponding to an entity associated with a location where said display is located.

20. The media presentation method of claim 10, wherein at least one of said plurality of sectors is a ticker sector that presents scrolling text-based information.

21. The media presentation method of claim 10, further comprising the step of:
establishing a temporary sector having an area of the display less than the program sector that overlays said program sector for a period less than a duration of the audio/video media production presented within the program sector, wherein during a presentation of the audio/video media production, the temporary sectors is displayed, advertisements are presented within the temporary sector, and then the temporary sector is removed.

22. The media presentation method of claim 10, further comprising the step of:
modifying the audio/video media production supplied by the audio/video media source before presentation within the display so that the audio/video media production includes a visually rendered object, which is specifically associated with a broker determined entity.

23. The media presentation method of claim 22, wherein the broker determined entity is selected from at least one of an advertiser that has paid said broker advertising revenue and an entity associated with a location where the display is located.

24. The media presentation method of claim 1, wherein at least one of said media productions comprises an audio/video production supplied by a television broadcast source and wherein at least one of said media productions is supplied by at least one of an Internet source, a Local Area Network (LAN) Source, and a Wide Area Network (WAN) source.

25. The presentation method of claim 24, wherein said media production supplied by the Internet source includes a graphic.

26. The presentation method of claim 1, wherein said selecting step is performed within a media box communicatively linked to said display that is provided by the broker and that is communicatively linked to a computing system of the broker.

27. The presentation method of claim 1, further comprising:
providing an interaction means for a viewer of said display to interact with content displayed within one of said media productions, wherein the interactive means permits said viewer to submit at least one information request; and
responsive to a submitted information request, altering the content displayed within the associated media production to provide viewer requested information.

28. The presentation method of claim 27, wherein the information request is submitted from a mobile telephony device of the viewer.

29. The presentation method of claim 28, wherein the information request comprises a code obtained from content displayed within the associated media production.

30. The presentation method of claim 28, wherein the mobile telephony device utilizes a short messaging service (SMS) based technology to submit the information request.

31. The presentation method of claim 1, wherein the display is configured to present three dimensional media productions, and wherein at least a portion of the media productions are three dimensional productions.

32. A media distribution method comprising the steps of:
identifying a plurality of displays at a plurality of locations, wherein a viewing area of each of said plurality of displays is divided into a plurality of defined sectors, each sector being configured to present a sector-specific media production, wherein one of the plurality of defined sections that is by viewing area the largest of the defined sectors presents an audio/video media production provided by an audio/video media source; and
selling presentation space to advertisers that permits advertisers that purchase presentation space to display advertiser-specified content within at least one of said defined sectors other than the sector associated with the audio/video media production.

33. The media distribution method of claim 32, wherein individuals wait at each of said locations to receive services associated with said locations.

34. The media distribution method of claim 33, wherein the selling step permits advertisers to specify characteristics of an audience that is to be presented with the advertiser specified content, said method further comprising:
for each location, identifying location-specific characteristics of an audience present at the location; and
selecting advertising content to present at each location by matching advertiser specified audience characteristics with location-specific characteristics.

35. The media distribution method of claim 34, further comprising:
for each location, identifying at least one time characteristic, said time characteristic including at least one of a time of day and a duration of viewing;
selecting advertising content to present at each location by matching advertiser specified audience characteristics with time characteristics.

36. The media distribution method of claim 34, wherein said selecting step is locally performed within media boxes, each media box is communicatively linked to at least one display, wherein a media broker that sells the presentation space to advertisers utilizes the media boxes to control content that is presented within the displays.

37. The media distribution method of claim 34, wherein the selecting step and the step of identifying location-specific characteristics occurs in real-time or in near-real time.

38. The media distribution method of claim 34, wherein location-specific characteristics for each location are determined using at least one software application that tracks individuals present at the location.

39. The media distribution method of claim 38, wherein the at least one software application includes at least one scheduling application that schedules individuals to receive said services.

40. The media distribution method of claim 32, wherein said plurality at least one of the plurality of defined sectors is an information sector that presents at least one of a weather, a current time, a current date, current stock information, and current news.

41. The media presentation method of claim 32, wherein at least one of said plurality of defined sectors is a ticker sector that presents scrolling text-based information.

42. The media presentation method of claim 32, wherein said plurality of displays comprise a first display and a second display that are coordinated with each other, so that when at least one viewer moves from an area proximate to the first display to an area proximate to the second display, a media production presented at least in part within said first display is responsively presented at least in part within said second display.

43. The media distribution method of claim 32, wherein at least one of the displays is configured to present three dimensional media productions within one or more of the defined sectors.

44. A machine readable storage, having stored thereon a computer program having a plurality of code sections executable by a machine for causing the machine to perform the steps of:
identifying a display capable of presenting audio/video content;
dividing a viewing area of said display into a plurality of sectors;
for each sector, selecting a media production in accordance with programmatically established criteria; and
simultaneously presenting said selected media productions within said display, wherein a broker determines a set of media productions available for selection and establishes at least a portion of said programmatically established criteria used in the selecting step, wherein said broker does not commercially distribute said media productions for presentation in non-sectorized displays.
